(19) United States
(12) Patent Application Publication
(10) Pub. No.: US 2023/0402025 A1
(43) Pub. Date: Dec. 14, 2023

(54) AUTOMATIC PERFORMANCE DEVICE, ELECTRONIC MUSICAL INSTRUMENT, PERFORMANCE SYSTEM, AUTOMATIC PERFORMANCE METHOD, AND PROGRAM

(71) Applicant: CASIO COMPUTER CO., LTD., Tokyo (JP)

(72) Inventors: Jun YOSHINO, Tokyo (JP); Toshiyuki TACHIBANATACHIBANA, Tokyo (JP)

(73) Assignee: CASIO COMPUTER CO., LTD., Tokyo (JP)

(21) Appl. No.: 18/239,305

(22) Filed: Aug. 29, 2023

Related U.S. Application Data
(63) Continuation of application No. PCT/JP2022/005277, filed on Feb. 10, 2022.

(30) Foreign Application Priority Data
Mar. 23, 2021 (JP) 2021-049183
Jul. 26, 2021 (JP) 2021-121361

(51) Int. Cl. G10H 1/26; G10H 1/08; G10H 1/34; G10H 1/40

(52) U.S. Cl. CPC G10H 1/26; G10H 1/08; G10H 1/34; G10H 1/40; G10H 2220/221

(57) ABSTRACT

An automatic performance device executing a process includes: determining stochastically one of a plurality of timing patterns indicating a sound production timing of a musical instrument sound, and determining a musical instrument tone designation table associated with the determined timing pattern from a plurality of musical instrument tone designation tables.

### CROSS-REFERENCE TO RELATED APPLICATIONS

This application is a continuation of International Patent Application No. PCT/JP2022/005277 filed on Feb. 10, 2022, and claims priority to Japanese Patent Applications Nos. 2021-049183 filed on Mar. 23, 2021, and 2021-121361 filed on Jul. 26, 2021; the entire content of both of which is incorporated herein by reference.

### TECHNICAL FIELD

The present invention relates to an automatic performance device, an electronic musical instrument, a performance system, an automatic performance method, and a program that automatically perform a rhythm part or the like.

### BACKGROUND ART

Conventionally, for example, in an automatic performance device that automatically performs a rhythm part, one to several bars of automatic performance patterns corresponding to rhythm types such as jazz, rock, and Waltz or the like are stored in a storage medium such as a ROM or the like. The automatic performance pattern includes a rhythm tone type that is a tone of a musical instrument constituting rhythm, such as a snare drum, a bass drum, a tom-tom or the like, and a sound production timing thereof. Then, when the rhythm type is selected and the automatic performance is started, the automatic performance pattern is sequentially read, and each rhythm musical instrument sound is produced at each sound production timing. Furthermore, when the automatic performance of one to several bars ends, the automatic performance pattern is read again. As a result, a rhythm pattern corresponding to one rhythm type is automatically performed repeatedly every one to several bars. Therefore, it is possible to play music including a rhythm sound by manually playing a melody sound or a chord following the automatic performance of the rhythm pattern.

However, in such a conventional automatic performance device, a rhythm pattern of one to several bars stored in advance is repeatedly and automatically performed. Therefore, the configuration of the automatically performed rhythm becomes monotonous. As a result, when the music is performed with an automatically performed rhythm sound, the rhythm configuration of the entire music becomes monotonous.

As a first prior art for solving the monotony described above in automatic performance, for example, there is known a prior art configured to include a first storage unit that stores first pattern data related to a motif, a second storage unit that stores second pattern data related to a change, a reading unit that reads first and second pattern data randomly extracted from the first and second storage units, and an automatic accompaniment unit that automatically generates an accompaniment sound on the basis of the first pattern data and the second pattern data read by the reading unit (for example, Japanese Patent Application Laid-Open No. 09-319372).

In addition, as a second prior art for solving the monotony as described above, there is known a prior art that includes an automatic performance pattern storage unit that stores an automatic performance pattern including normal sound data and random sound data, a probability data storage unit that stores probability data for determining a probability of sound production based on the random sound data, a reading unit that sequentially reads the automatic performance pattern from the automatic performance pattern storage unit, a sound production instruction unit that instructs sound production based on the normal sound data constituting the automatic performance pattern read by the reading unit and instructs sound production with a probability corresponding to the probability data based on the random sound data, and a musical sound generation unit that generates a musical sound according to a sound instruction from the sound production instruction unit (for example, Japanese Patent Application Laid-Open No. 04-324895).

### SUMMARY OF INVENTION

An automatic performance device according to an example of an aspect executes a process including determining stochastically one of a plurality of timing patterns indicating a sound production timing of a musical instrument sound, and determining a musical instrument tone designation table associated with the determined timing pattern from a plurality of musical instrument tone designation tables.

### BRIEF DESCRIPTION OF DRAWINGS

FIG. 1 is a diagram showing a hardware configuration example of an embodiment of an electronic musical instrument.

FIG. 2 is a flowchart showing an example of the main process of the automatic performance device.

FIGS. 3A and 3B are a diagram showing a musical score example and a data configuration example of a basic table in a basic drum pattern process.

FIG. 4 is a flowchart showing a detailed example of the basic drum pattern process.

FIGS. 5A to 5G are a diagram showing a musical score example and an example of a comping table in a variation drum process.

FIG. 6 is a diagram showing an actual data configuration example of a comping table.

FIGS. 7A to 7D are a diagram showing an example of an instrument table.

FIG. 8 is a flowchart showing a detailed example of the variation drum process.

FIG. 9 is a flowchart showing a detailed example of a comping pattern selection process.

FIG. 10 is a flowchart showing a detailed example of a frequency process.

FIG. 11 is a flowchart showing a detailed example of an instrument pattern selection process.

FIG. 12 is a diagram showing a connection form of another embodiment in which the automatic performance device and the electronic musical instrument individually operate.

FIG. 13 is a diagram showing a hardware configuration example of an automatic performance device in another embodiment in which the automatic performance device and the electronic musical instrument individually operate.

### DESCRIPTION OF EMBODIMENTS

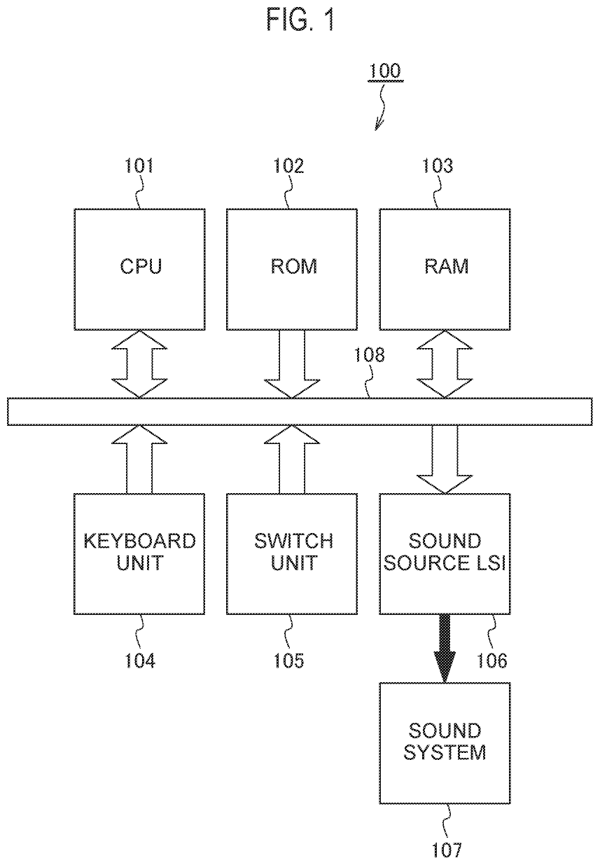

Hereinafter, embodiments of the present invention will be described in detail with reference to the drawings. FIG. 1 is a diagram illustrating a hardware configuration example of an embodiment of an electronic keyboard instrument which is an example of an electronic musical instrument. In FIG. 1, an electronic keyboard instrument 100 is implemented as, for example, an electronic piano, and includes a CPU (central process unit) 101, a ROM (read-only memory) 102, a RAM (random access memory) 103, a keyboard unit 104, a switch unit 105, and a sound source LSI 106, which are connected to each other via a system bus 108. The output of the sound source LSI 106 is input to the sound system 107.

The electronic keyboard instrument 100 has a function of an automatic performance device that automatically performs a rhythm part. Then, the automatic performance device of the electronic keyboard instrument 100 can automatically generate sound production data of automatic performance corresponding to a rhythm type such as jazz, rock, and Waltz or the like by an algorithm within a certain range of musical rules, instead of simply replaying the programmed data.

The CPU 101 loads the control program stored in the ROM 102 into the RAM 103 and executes the control program while using the RAM 103 as a working memory, thereby executing the control operation of the electronic keyboard instrument 100 of FIG. 1. In particular, the CPU 101 executes a control operation for automatically playing a rhythm part by loading the control program shown in a flowchart to be described later from the ROM 102 to the RAM 103 and executing the control program.

The keyboard unit 104 detects a key depression or key release operation of each key as a plurality of playing operators and notifies the CPU 101. In addition to the control operation for automatic performance of a rhythm part to be described later, the CPU 101 executes process of generating sound production instruction data for controlling sound production or silencing of a musical sound corresponding to a keyboard performance by a player on the basis of the detection notification of the key depression or key release operation notified from the keyboard unit 104. The CPU 101 notifies the sound source LSI 106 of the generated sound production instruction data.

The switch unit 105 detects operations of various switches by the player and notifies the CPU 101.

The sound source LSI 106 is a large-scale integrated circuit for generating musical sound. The sound source LSI 106 generates digital musical sound waveform data on the basis of the sound production instruction data input from the CPU 101 and outputs the digital musical sound waveform data to the sound system 107. The sound system 107 converts the digital musical sound waveform data input from the sound source LSI 106 into an analog musical sound waveform signal, amplifies the analog musical sound waveform signal with a built-in amplifier, and emits the signal from a built-in speaker.

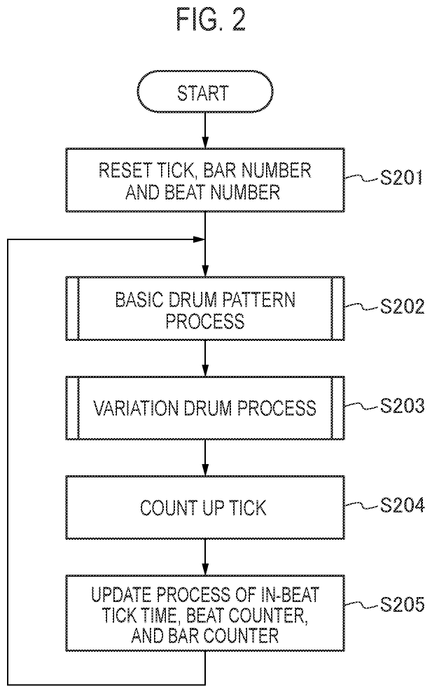

Details of the automatic performance process of a rhythm part according to the embodiment of the automatic performance device of the electronic keyboard instrument 100 having the above configuration (hereinafter referred to as “present automatic performance device”) will be described below. FIG. 2 is a flowchart showing an example of main process of the present automatic performance device. This process is a process in which the CPU 101 in FIG. 1 loads the program of the automatic performance control process stored in the ROM 102 into the RAM 103 and executes the program.

When the player operates the switch unit 105 in FIG. 1 to select a genre (for example, “jazz”) and a tempo of the automatic performance and then presses a start switch of the automatic performance (not shown) in the switch unit 105, the CPU 101 starts the main process exemplified in the flowchart in FIG. 2.

First, the CPU 101 executes a reset process (step S201). Specifically, in step S201, the CPU 101 resets the bar counter variable value stored in the RAM 103 indicating the bar number from the start of the automatic performance of the rhythm part to a value (for example, “1”) indicating the first bar of the automatic performance of the rhythm part. In step S201, the CPU 101 resets the beat counter variable value stored in the RAM 103 indicating a beat number (beat position) in the bar to a value (for example, “1”) indicating the first beat. Next, the control of the automatic performance by the automatic performance device proceeds in units of a value of a tick variable (hereinafter, the value of this variable is described as a “tick variable value”) stored in the RAM 103. In the ROM 102 of FIG. 1, a Time Division constant (hereinafter, a value of this constant is referred to as a “Time Division constant value”) indicating time resolution of automatic performance is set in advance, and this Time Division constant value indicates resolution of a quarter note. When this value is, for example, 96, the quarter note has a time length of “96×tick variable value”. Here, how many seconds 1 tick actually takes depends on a tempo specified for the rhythm part of the automatic performance. Now, in a case where the value set to the Tempo variable in the RAM 103 in accordance with the user setting is the “Tempo variable value [beat/min]”, the number of seconds of 1 tick (hereinafter referred to as “tick second numerical value”) is calculated by the following Formula (1).

[Formula (1)]

tick second numerical value=60/Tempo variable value/Time Division variable value (1)

Therefore, in the reset process in step S201 in FIG. 2, the CPU 101 first calculates the tick second numerical value by the arithmetic process corresponding to the above Formula (1), and stores the tick second numerical value under the “tick second variable” on the RAM 103. Note that the Tempo variable value may be initially set to a predetermined value read from a constant in ROM 102 in FIG. 1, for example, 60 [beats/second], in the initial state. Alternatively, the Tempo variable may be stored in a nonvolatile memory, and the Tempo variable value at the end of the previous time may be maintained as it is when the power of the electronic keyboard instrument 100 is turned on again.

Next, in the reset process in step S201 in FIG. 2, the CPU 101 first resets the tick variable value in the RAM 103 to 0. Thereafter, timer interruption based on a tick second numerical value calculated as described above and stored under the tick second variable in the RAM 103 is set to the hardware of the built-in timer (not shown). As a result, an interruption (hereinafter referred to as “tick interruption”) occurs every time the number of seconds of the tick second numerical value elapses in the timer.

In a case where the player operates the switch unit 105 in FIG. 1 to change the tempo of the automatic performance in the middle of the automatic performance, the CPU 101 calculates the tick second numerical value by executing the arithmetic process corresponding to the above-described Formula (1) again using the Tempo variable value reset to the Tempo variable value in the RAM 103 in the same manner as the reset process in step S201. Thereafter, the CPU 101 sets timer interruption based on a newly calculated tick second numerical value for the hardware of the built-in timer. As a result, tick interruption occurs every time the number of seconds of the newly set tick second numerical value elapses in the timer.

After the reset process in step S201, the CPU 101 repeatedly executes a series of processes from step S202 to S205 as a loop process. This loop process is repeatedly executed until the player turns off the automatic performance via a switch (not particularly shown) of the switch unit 105 in FIG. 1.

First, the CPU 101 counts up a tick counter variable value in the RAM 103 in a case where a new tick interruption occurs in the timer in a tick count-up process in step S204 in the loop process described above. Thereafter, the CPU 101 releases the tick interruption. In a case where the tick interruption has not occurred, the CPU 101 ends the process of step S204 as it is without counting up the tick counter variable value. As a result, the tick counter variable value is counted up every second of the tick second numerical value calculated corresponding to the Tempo variable value set by the player.

The CPU 101 controls the progress of the automatic performance based on the tick counter variable value counted up every second of the tick second numerical value in step S204. Hereinafter, a time unit synchronized with the tempo having the tick counter variable value=1 as a unit is described as [tick]. As described above, when the Time Division constant value indicating resolution of a quarter note is, for example, 96, the quarter note has a time length of 96 [tick]. Therefore, when the rhythm part automatically performed is, for example, 4 beats, 1 beat=96 [tick], and 1 bar=96 [tick]×4 beats=384 [tick]. In step S205 of the loop process described above, for example, in a case where a 4-beat rhythm part is selected, the CPU 101 loops and updates the beat counter variable value stored in the RAM 103 every time the tick counter variable value becomes a multiple of 96, in a pattern of 1, 2, 3, 4, 1, 2, 3 . . . , and so on between 1 and 4. In addition, in step S205, the CPU 101 resets the in-beat tick counter variable value for counting the tick time from the beginning of each beat to 0 at the timing when the beat counter variable value changes. Further, in step S205, the CPU 101 counts up the bar counter variable value stored in the RAM 103 incrementally at the timing when the beat counter variable value changes from 4 to 1. That is, the bar counter variable value represents the bar number from the start of the automatic performance of the rhythm part, and the beat counter variable value represents the beat number (beat position) in each bar represented by the bar counter variable value.

The CPU 101 executes the basic drum pattern process of step S202 and executes the variation drum process of step S203 while repeatedly executing steps S204 and S205 as the loop process to update the tick counter variable value, the in-beat tick counter variable value, and the bar counter variable value.

Details of the basic drum pattern process of step S202 in FIG. 2 will be described below. The basic drum pattern process does not involve a process that stochastically determines the drum pattern, or the like, and is a process of sound production of a basic automatic performance drum pattern (hereinafter referred to as “basic pattern”) that is constantly produced by a ride cymbal (hereinafter referred to as “Ride”) and a pedal hi-hat (hereinafter referred to as “PHH”).

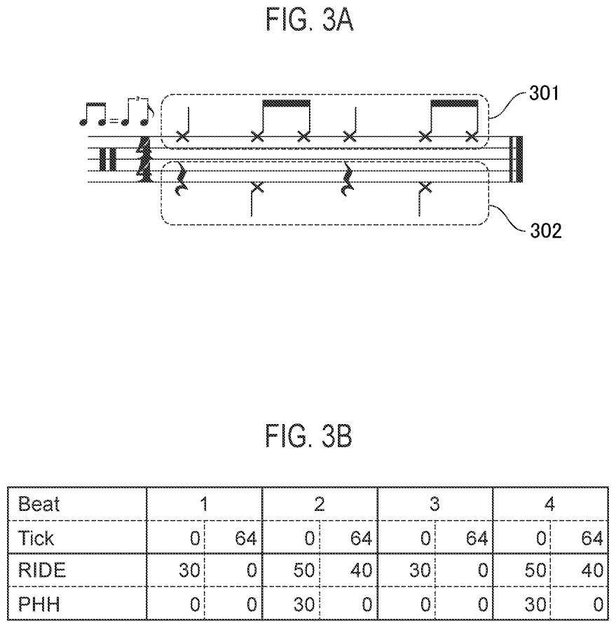

FIG. 3A is a diagram showing a musical score example of the basic pattern. FIG. 3B is a diagram showing a data configuration example of table data (hereinafter referred to as “basic table”) stored in the ROM 102 of FIG. 1 for controlling the sound production of the basic pattern exemplified as the musical score example of FIG. 3A. The musical score example of FIG. 3A is an example of a rhythm part of eight-beat shuffle by Ride and PHH.

In the eight-beat shuffle, in the musical score example in FIG. 3A, the first note of an eighth-note duplet corresponds to a combined note length of a first note length and a second note length of the triplet during the performance, and the second note of the eighth-note duplet corresponds to a third note length of the triplet during the performance. As described above, in the eight-beat shuffle, an off-beat of the eighth-note described in the musical score of the rhythm part is equivalent to a timing of the third note of the triplet at the time of performance. That is, in the eight-beat shuffle, the off-beat of the eighth-note is produced later than the normal eight-beat.

In the musical score example of FIG. 3A, a portion surrounded by a broken line frame 301 indicates a sound production timing group of Ride. These sound production timing groups indicate that, in the eight-beat shuffle, the Ride sounds for three triplets at the time of performance are produced in each on-beat of a first beat and a third beat of the repeated bar, the Ride sounds for two triplets at the time of performance are produced in each on-beat of a second beat and a fourth beat of the repeated bar, and the Ride sounds for one triplet at the time of performance are produced in each off-beat of the repeated bar.

In the musical score example of FIG. 3A, a portion surrounded by a broken line frame 302 indicates a sound production timing group of PHH. These sound production timing groups indicate that, in the eight-beat shuffle, each on-beat of a first beat and a third beat of the repeated bar is a rest, and PHH sounds for two triplets at the time of performance is produced in each on-beat of a second beat and a fourth beat.

Next, in the basic table exemplified in FIG. 3B, each column of the table to which numbers “1”, “2”, “3”, and “4” are assigned in the “Beat” row respectively indicates information for controlling the sound production at each timing of the first beat, the second beat, the third beat, and the fourth beat in the repeated bar.

In the basic table exemplified in FIG. 3B, each column of the table to which numbers “0” and “64” are repeatedly assigned in the “Tick” row indicates information for controlling the sound production at each timing of the 0 [tick] and the 64th [tick] from the beginning of each beat in the bar indicated by each number in the “Beat” row. As described above, the time of one beat is, for example, 96 [tick]. Therefore, 0 [tick] is the timing of the beginning of each beat and corresponds to the on-beat of the above-described eight-beat shuffle (the timing of the start of the combined note length of the first note and the second note of the triplet during performance). On the other hand, 64 [tick] is the timing at which time has elapsed from the beginning of each beat to 64 [tick], and corresponds to the off-beat of the eight-beat shuffle described above (the timing of the start of the note length of the third note of the triplet during the performance). That is, each number in the “Tick” row indicates the in-beat tick time of a beat indicated by the “Beat” row that includes the number in the column where the number is placed. In a case where the rhythm part is an eight-beat shuffle of a jazz part, for example, the in-beat tick time “0” indicating the on-beat and the in-beat tick time “64” indicating the off-beat are set as the respective numbers in the “Tick” row.

In the basic table exemplified in FIG. 3B, each number in the “Ride” row indicates that the Ride sound should be produced at the velocity indicated by the number at the sound production timing indicated by the beat number in the bar in the “Beat” row and the in-beat tick time in the “Tick” row in the column where the number is placed. When the number is “0”, it indicates velocity “0”, that is, the Ride sound should not be produced.

For example, at the timing of the on-beat of the first beat in the bar where the “Beat” row is “1” and the “Tick” row is “0”, it is indicated that Ride sound should be produced at velocity “30”. At the timing of the off-beat of the first beat in the bar where the “Beat” row is “1” and the “Tick” row is “64”, it is indicated that the velocity of Ride is “0”, that is, the Ride sound should not to be produced. At the timing of the on-beat of the second beat in the bar where the “Beat” row is “2” and the “Tick” row is “0”, it is indicated that Ride sound should be produced at velocity “50”. At the timing of the off-beat of the second beat in the bar where the “Beat” row is “2” and the “Tick” row is “64”, it is indicated that Ride sound should be produced at velocity “40”. In the third beat in the bar where the “Beat” row is “3”, the same sound production instruction as in the first beat is given. In the fourth beat in the bar where the “Beat” row is “4”, the same sound production instruction as in the second beat is given.

In the basic table exemplified in FIG. 3B, each number in the “PHH” row indicates that the PHH sound should be produced at the velocity indicated by the number at the sound production timing indicated by the beat number in the bar in the “Beat” row and the in-beat tick time in the “Tick” row in the column where the number is placed. When the number is “0”, it indicates velocity “0”, that is, the PHH sound should not be produced.

For example, at each timing of each of the on-beat and the off-beat of the first beat and the third beat in the bar where the “Beat” row is “1” and “3” and the “Tick” row is “0” and “64”, respectively, it is indicated that the velocity of the PHH is “0”, that is, the PHH sound should not be produced. At the timing of each on-beat of the second beat and the fourth beat in the bar where the “Beat” row is “2” and “4” and the “Tick” row is “0”, it is indicated that the PHH sound should be produced at velocity “30”. At the timing of each off-beat of the second beat and the fourth beat in the bar where the “Beat” row is “2” and “4” and the “Tick” row is “64”, it is indicated that the velocity of the PHH is “0”, that is, the PHH sound should not be produced.

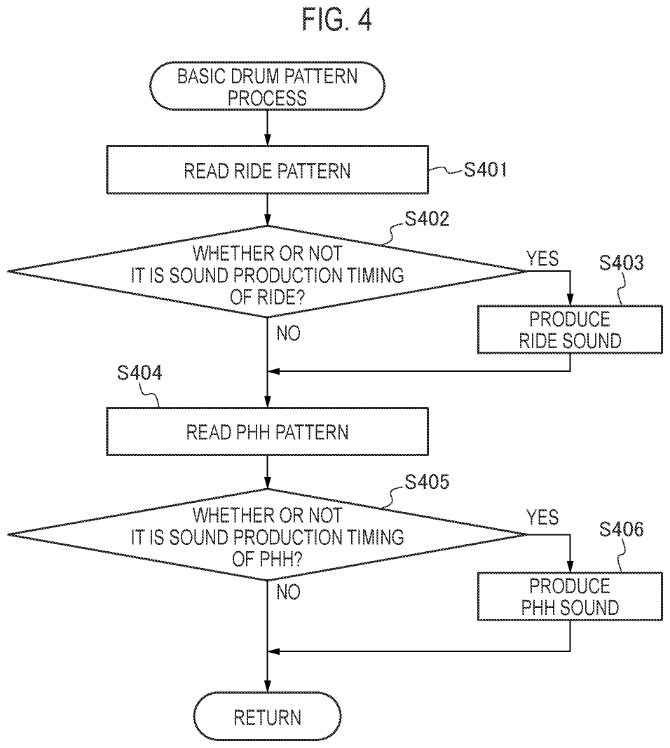

FIG. 4 is a flowchart showing a detailed example of the basic drum pattern process of step S202 in FIG. 2 for performing the automatic performance control of the basic pattern exemplified in FIG. 3A based on the basic table data in the ROM 102 exemplified in FIG. 3B. First, the CPU 101 reads, from the basic table data in the ROM 102, the Ride pattern data, which is a set of data of each column of the “Ride” row exemplified in FIG. 3B, as a set of the velocity data set for each column, the beat data of the “Beat” row exemplified in FIG. 3B including each column, and the in-beat tick time data of the “Tick” row including each column (step S401).

Next, the CPU 101 compares the current beat counter variable value and in-beat tick counter variable value (see step S205 in FIG. 2) in the RAM 103 with the beat data, the in-beat tick time data, and the velocity data in each column of the Ride pattern data read in step S401, thereby determining whether or not the current sound production timing is the sound production timing of the Ride sound (step S402).

When the determination in step S402 is YES, the CPU 101 issues, to the sound source LSI 106 in FIG. 1, a sound production instruction of a musical sound by the preset Ride tone and the velocity of the Ride pattern data determined by the determination process of step S402. As a result, the sound source LSI 106 generates musical sound waveform data of the Ride sound that is instructed to be produced. Then, a musical sound of the Ride sound is produced via the sound system 107 (as described above, step S403).

When the determination in step S402 is NO, or after the process of step S403, the CPU 101 reads, from the basic table data in the ROM 102, the PHH pattern data, which is a set of data of each column of the “PHH” row exemplified in FIG. 3B, as a set of the velocity data set for the column, the beat data of the “Beat” row exemplified in FIG. 3B including the column, and the in-beat tick time data of the “Tick” row including the column (step S404).

Next, the CPU 101 compares the beat counter variable value and the in-beat tick counter variable value (see step S205 in FIG. 2) in the RAM 103 with the beat data, the in-beat tick time data, and the velocity data in each column of the PHH pattern data read in step S404, thereby determining whether or not the current sound production timing is the sound production timing of the PHH sound (step S405).

When the determination in step S405 is YES, the CPU 101 issues, to the sound source LSI 106 in FIG. 1, a sound production instruction of a musical sound by the preset PHH tone and the velocity of the PHH pattern data determined by the determination process of step S405. As a result, the sound source LSI 106 generates musical sound waveform data of the PHH sound that is instructed to be produced. Then, a musical sound of the PHH sound is produced via the sound system 107 (as described above, step S406).

When the determination in step S405 is NO, or after the process of step S406, the CPU 101 ends the basic drum pattern process of step S202 in FIG. 2 exemplified in the flowchart in FIG. 4 at the present tick time timing.

Next, variation drum process of step S203 in FIG. 2 will be described below. For example, in the eight-beat shuffle in the rhythm part of jazz, in FIG. 3A described above, a basic pattern of one bar of the Ride sound and the PHH sound is repeatedly produced by automatic performance. In addition, in a music genre such as jazz or the like, a playing method called comping is known. The comping refers to the act of a drummer or the like playing chords, rhythms, and countermelodies to support a musician's improvised solos or melody lines. In correspondence with the comping, in the present automatic performance device, a rhythm pattern of a snare drum (hereinafter, referred to as “SD”), a bass drum (hereinafter, referred to as “BD”), or a tom-tom (hereinafter, referred to as “TOM”) is stochastically generated to flavor the basic pattern, and a corresponding musical sound is produced. In the present automatic performance device, these stochastically generated rhythm patterns are referred to as comping patterns.

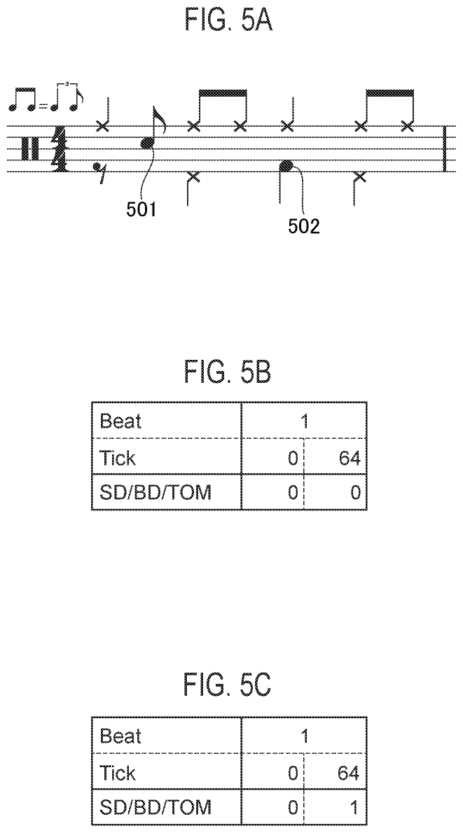

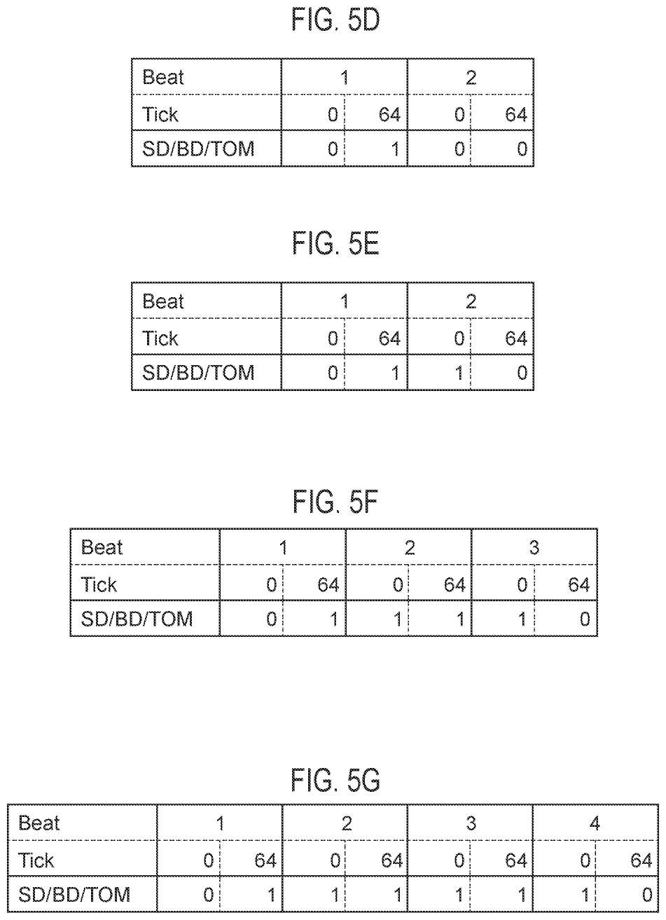

FIG. 5A is a diagram showing a musical score example of a comping pattern plus the basic pattern of FIG. 3A. FIGS. 5B, 5C, 5D, 5E, 5F, and 5G are diagrams showing a data configuration example of table data (hereinafter, referred to as “comping table”) stored in the ROM 102 in FIG. 1 for controlling the sound production of the comping pattern exemplified as 501 and 502 of the musical score example of FIG. 5A. The comping table is a table indicating a plurality of timing patterns indicating sound production timing of a musical instrument such as SD, BD, or TOM, or the like. The musical score example of FIG. 5A is an example of a rhythm part of the eight-beat shuffle including a basic pattern by Ride (a pattern surrounded by a broken line frame 301) and a basic pattern by PHH (a pattern surrounded by a broken line frame 302) shown in the musical score example of FIG. 3A, and, for example, a comping pattern 501 by SD and a comping pattern 502 by BD.

The sound production timing example of the basic pattern in FIG. 5A is similar to the case of FIG. 3A. In FIG. 5A, the comping pattern 501 by SD and the comping pattern 502 by BD are stochastically added.

The basic table for generating the basic pattern described above is, for example, fixed table data of one bar as illustrated in FIG. 3B. On the other hand, in the present automatic performance device, as the comping table for stochastically adding a comping pattern, a plurality of pieces of beat length table data are prepared as exemplified in FIGS. 5B, 5C, 5D, 5E, 5F, and 5G.

In the comping tables exemplified in FIGS. 5B to 5G, meanings of the “Beat” row and the “Tick” row are the same as in the case of the basic table exemplified in FIG. 3B. In addition, each number “1” in the “SD/BD/TOM” row indicates that any of the SD sound, the BD sound, or the TOM sound should be produced at the sound production timing indicated by the beat number in the bar in the “Beat” row and the in-beat tick time in the “Tick” row in the column where the number is placed. When the number is “0”, it is indicated that none of the SD sound, the BD sound, or the TOM sound should be produced. Note that the type and the velocity of the musical instrument sound produced among the SD sound, the BD sound, or the TOM sound at each sound production timing are not determined by referring to the comping table, but are determined by referring to the instrument table to be described later.

In the present automatic performance device, one comping pattern is stochastically selected from the comping table (the comping pattern storage means) exemplified in FIG. 5B, 5C, 5D, 5E, 5F, or 5G stored in the ROM 102 in FIG. 1. As a result, while variations of various comping patterns including a comping pattern continuing over one on-beat or one off-beat, a comping pattern continuing over two on-beats or two off-beats, a comping pattern continuing over three on-beats or three off-beats, or a comping pattern continuing over four on-beats or four off-beats (one bar in the present embodiment) are, for example, randomly selected, sound production instruction data is generated for instructing a sound production at each sound production timing over each beat of the length of the beat number in the selected comping pattern (hereinafter referred to as “beat length”) and the on-beat and the off-beat in each beat. A process is repeatedly executed in which when a sound production instruction for a comping pattern of one beat length ends, a comping pattern of the next beat length is stochastically selected.

As described above, in the present automatic performance device, the comping patterns of the beat number of various beat lengths (variable lengths) are stochastically selected, and the sound production instruction is sequentially performed. Therefore, as compared with a case where many variations of rhythm patterns are stored in units of bars as in the prior art, it is possible to perform automatic performance with a comping pattern in which sound production timing changes variously with a small storage capacity. At this time, since the musical motif of the rhythm part can be provided as the basic pattern, for example, the automatic performance of the rhythm part is not performed with an inharmonious musical motif.

Note that, since there may be a performance to which none of the comping patterns of the SD sound, the BD sound, and the TOM sound is added, for example, a comping pattern illustrated in FIG. 5B that does not instruct sound production at all is also prepared.

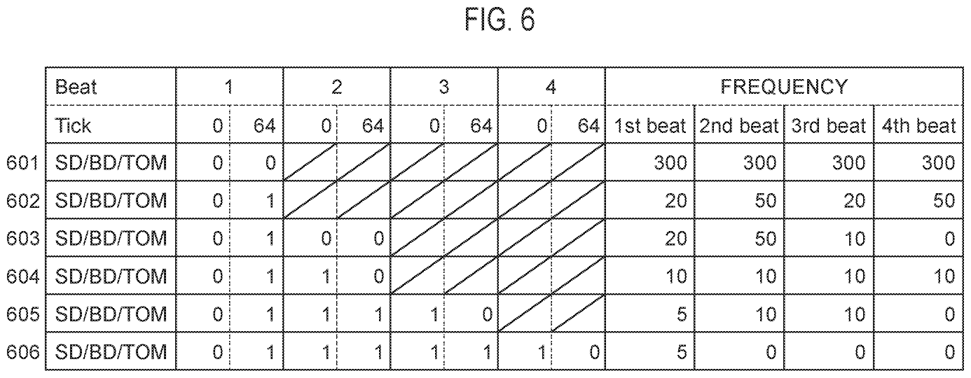

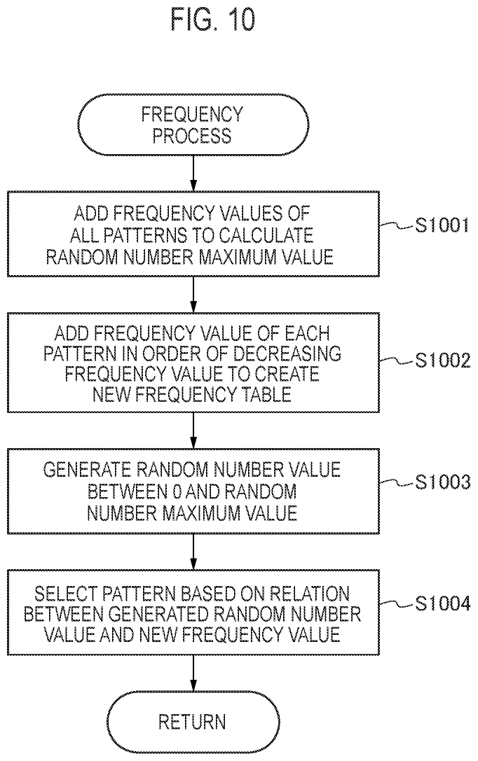

The comping tables exemplified in FIGS. 5B, 5C, 5D, 5E, 5F, and 5G are actually stored in the ROM 102 in FIG. 1 in the data format shown in FIG. 6. In FIG. 6, the comping pattern of each “SD/BD/TOM” row of 601 to 606 corresponds to each of the comping patterns of the comping table exemplified in FIGS. 5B, 5C, 5D, 5E, 5F, and 5G. Further, in the column “1st beat” included in the “frequency” item in FIG. 6, a frequency value is registered which is timing pattern frequency data indicating a probability that a comping pattern of each “SD/BD/TOM” row is read when a timing at which a comping pattern is read next (a value indicated by a beat counter variable value at that time) is a timing of a first beat in a bar. The greater the frequency value, the greater the probability that the comping pattern of the “SD/BD/TOM” row in which the frequency value is set is selected. Similarly, in each of the columns “2nd beat”, “3rd beat”, and “4th beat” included in the “frequency” item in FIG. 6, a frequency value is registered which indicates a probability that a comping pattern of each “SD/BD/TOM” row is read when a timing at which a comping pattern is read next (a value indicated by a beat counter variable value at that time) is a timing of a second beat, a third beat, and a fourth beat in a bar. A method of calculating the probability corresponding to the frequency value will be described later with reference to the flowchart of the frequency process of FIG. 10.

Here, for example, in FIG. 6, the frequency values at “2nd beat”, “3rd beat”, and “4th beat” of the comping pattern in the 606 “SD/BD/TOM” row are all 0 because the comping pattern has a length of one bar and there are overwhelmingly many phrases based on the premise of being hit by four beats, and thus control is performed such that timings do not occur except the timing of the first beat. The reason why the frequency in the “4th beat” of the comping pattern in the 605 “SD/BD/TOM” row is 0 is also the same as the above reason.

On the other hand, in FIG. 6, the reason why the frequency value in the “4th beat” in the 604 “SD/BD/TOM” row and the “3rd beat” in the 605 “SD/BD/TOM” row is not is that the purpose is not to complete the pattern of 2 beats or 3 beats within a bar, and the combination of phrases of 2 beats or 3 beats does not cause a feeling of mannerism that is always completed with 4 beats. For example, in order to realize a case where the same three-beat pattern is connected by jumping a bar, control is performed so as not to fall within the frame of four beats (the bar).

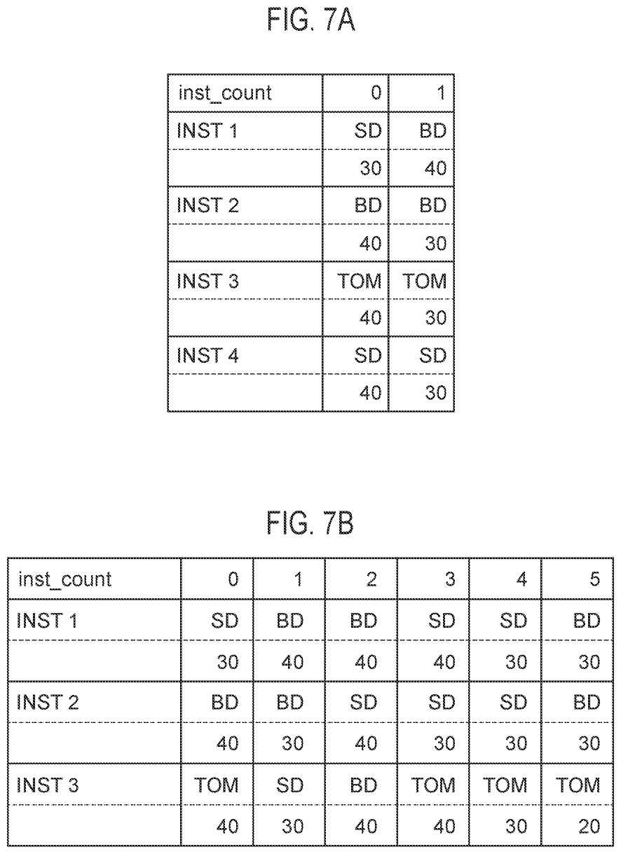

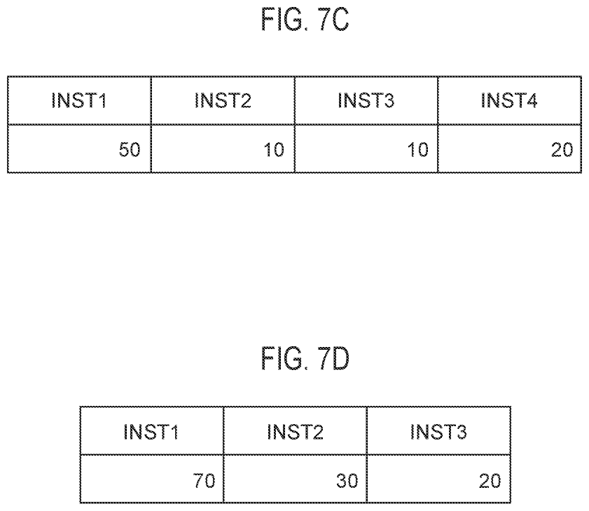

Next, determination process of musical instrument tones and velocities of the comping pattern will be described. FIG. 7 is a diagram showing an example of an instrument table, which is a musical instrument tone designation table for designating musical instrument tones and velocities. In the present automatic performance device, after each beat of the comping pattern having a certain beat length and the sound production timing of the on-beat and the off-beat in the beat are determined as described above, one instrument pattern is then stochastically selected from one or more instrument patterns registered in the instrument table prepared for the selected comping pattern. As a result, which musical instrument sound of the SD, the BD, or the TOM and which velocity are used for sound production are determined for each sound production timing.

FIG. 7A is an example of an instrument table corresponding to the comping pattern in FIG. 5E or in 604 of FIG. 6. In the comping pattern in FIG. 5E or in 604 of FIG. 6, the sound productions at two sound production timings of the off-beat of the first beat and the on-beat of the second beat are instructed. Therefore, also as the instrument pattern exemplified in FIG. 7A, two sets each including a musical instrument tone and a velocity corresponding to two sound production timings are prepared as exemplified as “0” and “1” in the “inst_count” row. Further, as variations of these sets, for example, four kinds of variations of INST1, INST2, INST3, and INST4 are prepared. For example, in the instrument pattern INST1, it is instructed to produce the SD sound with the velocity “30” at the first sound production timing (off-beat of the first beat) where the “inst_count” row is “0” and produce the BD sound with the velocity “40” at the second sound production timing (on-beat of the second beat) where the “inst_count” row is “1”. In the other instrument patterns INST2, INST3, and INST4, different combinations of musical instrument sounds and velocities are instructed.

FIG. 7B is an example of an instrument table corresponding to the comping pattern in FIG. 5G or in 606 of FIG. 6. In the comping pattern in FIG. 5G or FIG. 6, the sound productions at six sound production timings is instructed. Therefore, also as the instrument pattern exemplified in FIG. 7B, six sets each including a musical instrument tone and a velocity corresponding to six sound production timings are prepared as exemplified as “0” to “5” in the “inst_count” row. Further, as variations of these sets, for example, three kinds of variations of INST1, INST2, and INST3 are prepared.

In the present automatic performance device, one instrument pattern is stochastically selected from, for example, a plurality of instrument patterns in the instrument table corresponding to the comping pattern selected as described with reference to FIGS. 5 and 6. Specifically, for example, the frequency tables (hereinafter referred to as “instrument frequency table”) of FIGS. 7C and 7D set for each of the instrument tables of FIGS. 7A and 7B are referred to. In the instrument frequency table of FIG. 7C, it is instructed that the respective instrument patterns INST1, INST2, INST3, and INST4 in the instrument table of FIG. 7A are selected with probabilities corresponding to the frequency values 50, 10, 10, and 20, respectively. The frequency value is musical instrument tone frequency data indicating easiness of selection of each of a plurality of different musical instrument tones included in the musical instrument tone designation table. The larger the frequency value, the higher the probability of being selected. A method of calculating the probability corresponding to the frequency value will be described later with reference to the flowchart of the frequency process of FIG. 10. In the instrument frequency table of FIG. 7D, it is instructed that the respective instrument patterns INST1, INST2, and INST3 in the instrument table of FIG. 7B are selected with probabilities corresponding to the frequency values 70, 30, and 20, respectively.

As described above, in the present automatic performance device, the comping patterns having various variable-length beats lengths are stochastically selected and instructed to produce sound one after another, and instrument patterns having various combinations of musical instrument tones and velocities corresponding to the selected comping patterns are also stochastically selected and instructed to produce sound with the selected musical instrument sound and the velocity. Therefore, it is possible to perform automatic performance by an instrument pattern in which the combination of the musical instrument sound and the velocity variously changes with a small storage capacity instead of a uniform musical instrument sound as in the prior art. That is, the present automatic performance device can generate a comping pattern according to “the number of combinations of the comping patterns×the number of combinations of the instrument patterns for each of the comping patterns”.

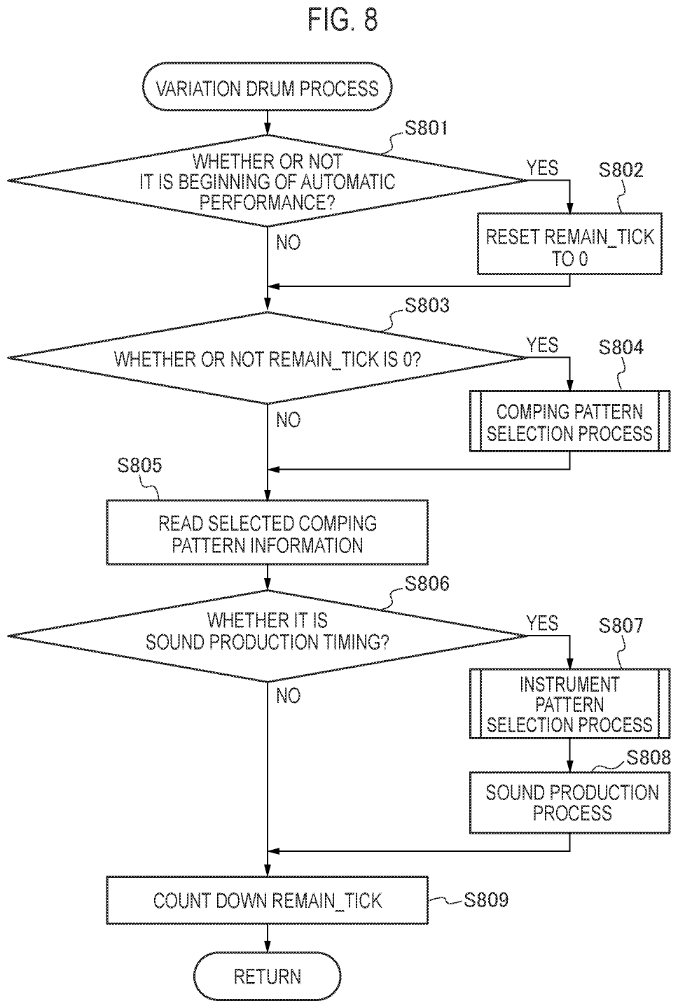

FIG. 8 is a flowchart showing a detailed example of the variation drum process of step S203 in FIG. 2 for performing the automatic performance control of the comping pattern and the instrument pattern. First, the CPU 101 determines whether or not the current timing is the beginning of the automatic performance (step S801). Specifically, the CPU 101 determines whether or not the tick counter variable value in the RAM 103 is 0.

When the determination in step S801 is YES, the CPU 101 resets the value of the remain_tick variable indicating the tick unit remaining time number in one comping pattern stored in the RAM 103 to 0 (step S802).

When the determination in step S801 is NO, the CPU 101 skips the process of step S802.

Next, the CPU 101 determines whether or not the remain_tick variable value in the RAM 103 is 0 (step S803).

When the remain_tick variable value is reset to 0 at the beginning of the automatic performance in step S802, or when the process of each sound production timing in one comping pattern is completed and the remain_tick variable value becomes 0, the determination in step S803 becomes YES. In this case, the CPU 101 executes a comping pattern selection process, which is the process for selecting a comping pattern described with reference to FIGS. 5 and 6 (step S804).

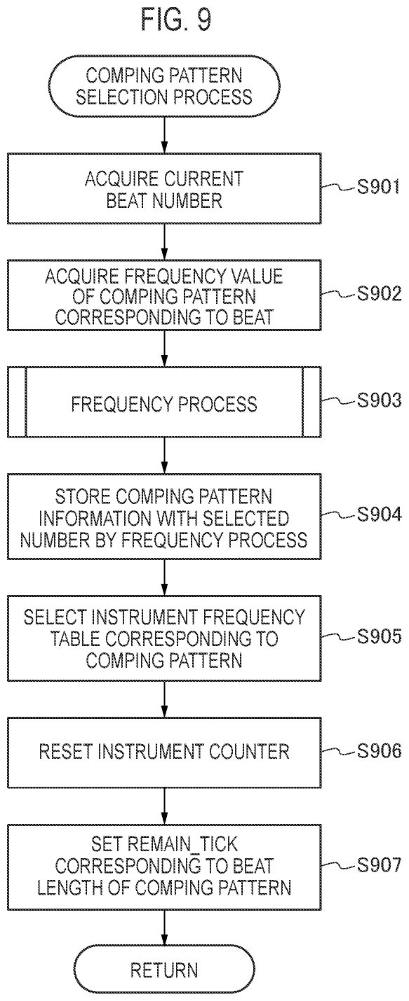

FIG. 9 is a flowchart showing a detailed process example of the comping pattern selection process of step S804 in FIG. 8. In FIG. 9, the CPU 101 first refers to the beat counter variable value in the RAM 103 (see step S205 in FIG. 2) to acquire the beat number in the current bar (step S901).

Next, the CPU 101 accesses the comping table stored in the ROM 102 in FIG. 1, and acquires the frequency value on the comping table corresponding to the current beat number acquired in step S901 (step S902). For example, when the current beat number is the first beat, the CPU 101 acquires the frequency value of each of the comping patterns of 601 to 606 in the “1st beat” in the comping table exemplified in FIG. 6. Similarly, when the current beat number is the 2nd, 3rd, or 4th beat, the CPU 101 acquires the frequency value of each of the comping patterns of 601 to 606 in the “2nd beat”, “3rd beat”, or “4th beat” in the comping table exemplified in FIG. 6.

Following step S902, the CPU 101 executes the frequency process (step S903). FIG. 10 is a flowchart showing a detailed example of the frequency process of step S903 of FIG. 9. In FIG. 10, first, in a case where N (N is a natural number) comping patterns are stored in the comping table, the CPU 101 sets each frequency value of the N comping patterns in the comping table corresponding to the current beat number acquired in step S902 in FIG. 9 as fi (1≤i≤N). In this case, the CPU 101 executes the calculation represented by the following Formula (2), calculates the calculation result as the random number maximum value rmax, and stores the calculation result in the RAM 103 (step S1001).

$$[ Mathematical formula 1 ]$$

$${r}_{max} = {\sum }_{i = 1}^{N} {f}_{i} \qquad ( 2 )$$

For example, in a case where the current beat number is the first beat, in step S902 in FIG. 9, when f1=300, f2=20, f3=20, f4=10, f5=5, and f6=5 are acquired as the frequency values of the comping patterns of 601 to 606 in the “first beat” where N=6 in the first beat from the comping table exemplified in FIG. 6, according to Formula (2) described above: 300+20+20+10+5+5=360 is calculated as the random number maximum value rmax.

Next, the CPU 101 sequentially adds each frequency value fi (1≤i≤N) of the N comping patterns acquired in step S902 in FIG. 9 by the calculation shown in the following Formula (3) to create a new frequency value fnewj (1≤j≤N) having each addition result as a component (step S1002).

$$[ Mathematical formula 2 ]$$

$${fnew}_{j} = {\sum }_{i = 1}^{j} {f}_{i} \qquad ( 3 )$$

For example, in step S902 in FIG. 9, the new frequency value fnewj (1≤j≤6) is calculated as follows by the calculation of the above Formula (3) using the frequency values of the comping patterns, f1=300, f2=20, f3=20, f4=10, f5=5, and f6=5, which are acquired from the comping table exemplified in FIG. 6.
300 . . . fnew1
300+20=320 . . . fnew2
300+20+20=340 . . . fnew3
300+20+20+10=350 . . . fnew4
300+20+20+10+5=355 . . . fnew5
300+20+20+10+5+5=360 . . . fnew6

Next, the CPU 101 generates a random number r between 0 and the random number maximum value rmax, for example, between 0 and 360 (step S1003).

Then, the CPU 101 determines any j (1≤j≤N) that satisfies the condition of the following Formula (4) between the generated random number r and the new frequency value fnewj (1≤j≤N), and selects the j-th comping pattern corresponding to the j (step S1004).

[Mathematical formula 3]

fnewⱼ₋₁<r≤fnewⱼ(1≤j≤N) Here, fnew₀=0 (4)

For example, in the above example, in a case of “0<r≤fnew1=300”, the first comping pattern of 601 in the comping table in FIG. 6 is selected. In a case of “fnew1=300<r≤fnew2=320”, the second comping pattern of 602 in the comping table in FIG. 6 is selected. In a case of “fnew2=320<r≤fnew3=340”, the third comping pattern of 603 in the comping table in FIG. 6 is selected. In a case of “fnew3=340<r≤fnew4=350”, the fourth comping pattern of 604 in the comping table in FIG. 6 is selected. Further, in a case of “fnew4=350<r≤fnew5=355”, the fifth comping pattern of 605 in the comping table in FIG. 6 is selected. Then, in a case of “fnew5=355<r≤fnew6=360”, the sixth comping pattern of 606 in the comping table in FIG. 6 is selected.

Thereafter, the CPU 101 ends the frequency process of step S903 in FIG. 9 exemplified in the flowchart in FIG. 10.

Returning to the description of FIG. 9, in a case where the number of columns is K where the value of the “SD/BD/TOM” row is “1”, from the comping pattern with number j selected by the frequency process of step S903, the CPU 101 generates a set (bi, ti) (1≤i≤K) of the beat number bi of the “Beat” row and the in-beat tick time ti of the “Tick” row in each column as the selected comping pattern information (bi, ti) (1≤i≤K), and stores the set in the RAM 103 (step S904).

For example, when the fourth comping pattern of 604 in the comping table in FIG. 6 is selected, the number of columns K where the value of the “SD/BD/TOM” row is “1” is 2. As a result, among the above two columns, a set (1, 64) of the beat number bi=1 in the “Beat” row and the in-beat tick time ti=64 in the “Tick” row in the first column and a set (2, 0) of the beat number bi=2 in the “Beat” row and the in-beat tick time ti=0 in the “Tick” row in the second column are generated as the selected comping pattern information (bi, ti) (1≤i≤2) and stored in the RAM 103.

Subsequently, the CPU 101 specifies an instrument table stored in the ROM 102 in FIG. 1 including data indicating a sounding instrument and a velocity for each sound production timing of the comping pattern corresponding to the comping pattern with number j selected by the frequency process of step S903. Further, the CPU 101 selects an instrument frequency table corresponding to the specified instrument table (step S905).

For example, it is assumed that the above-described comping pattern in FIG. 5E or in 604 is selected from the above-described comping table exemplified in FIG. 5 or FIG. 6 stored in the ROM 102 by the frequency process of step S903. In the comping pattern in FIG. 5E or in 604 of FIG. 6, the sound productions at two sound production timings of the off-beat of the first beat and the on-beat of the second beat are instructed. Therefore, the CPU 101 specifies the instrument table exemplified in FIG. 7A described above in which two sound production timings of “0” and “1” in the “inst_count” row are designated among the instrument tables stored in the ROM 102. Then, the CPU 101 selects the above-described instrument frequency table exemplified in FIG. 7C corresponding to the specified instrument table exemplified in FIG. 7A.

Further, the CPU 101 resets the value of the instrument counter variable, which is a variable stored in the RAM 103 for designating each sound production timing designated by the “inst_count” row in the instrument table, to 0 (step S906).

Then, the CPU 101 sets a value corresponding to the beat length of the comping pattern with number j selected by the frequency process of step S903 to the remain_tick variable which is a variable in the RAM 103 (step S907).

For example, when it is assumed that the above-described comping pattern in FIG. 5E or in 604 is selected from the above-described comping table exemplified in FIG. 5 or FIG. 6 stored in the ROM 102 by the frequency process of step S903, the value “2” is set as the remain_tick variable value since the beat length of the comping pattern is 2 beats.

Thereafter, the CPU 101 ends the comping pattern selection process of step S804 in FIG. 8 exemplified in the flowchart in FIG. 9.

Returning to the description of FIG. 8, when the determination in step S803 is NO (the remain_tick variable value is not 0), or after the process of step S804, the CPU 101 reads the selected comping pattern information (bi, ti) (1≤i≤K) stored in the RAM 103 in step S904 in FIG. 9 (step S805).

Next, the CPU 101 determines whether or not the current timing is a sound production timing designated by the comping pattern information read in step S805 (step S806). Specifically, the CPU 101 determines whether or not the set of the current beat counter variable value and in-beat tick time variable value stored in the RAM 103, which are updated in step S205 in FIG. 2, matches any set of the comping pattern information (bi, ti) (1≤i≤K) read in step S805. Here, bi is the beat number in the “Beat” row and ti is the in-beat tick time in the “Tick” row in each column of the comping pattern.

For example, when (bi, ti)=(1, 64) and (2, 0) are read as the comping pattern information in FIG. 5E or in 604 in step S805, it is determined whether or not either “the beat counter variable value=1 and the in-beat tick time=64” or “the beat counter variable value=2 and the in-beat tick time=0”.

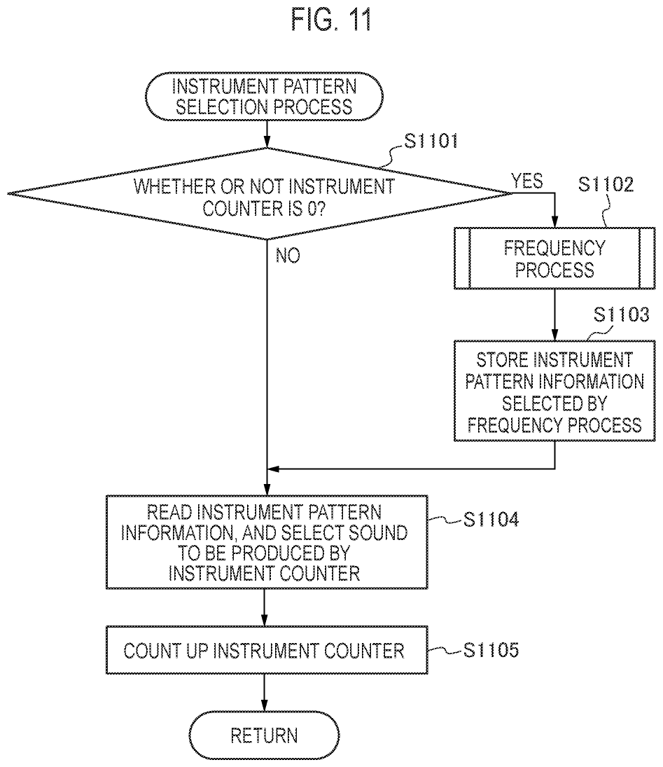

When the determination in step S806 is YES, the CPU 101 executes an instrument pattern selection process (step S807). FIG. 11 is a flowchart showing a detailed process example of the instrument pattern selection process of step S807 in FIG. 8.

In FIG. 11, the CPU 101 first determines whether or not the instrument counter variable value stored in the RAM 103 is 0 (step S1101).

The instrument counter variable value is reset to 0 in step S906 when the comping pattern is selected in FIG. 9 in the comping pattern selection process of step 804 in FIG. 8. Therefore, at this timing, the determination in step S1101 is YES. In this case, the CPU 101 executes the frequency process (step S1102). Here, the CPU 101 executes a process of stochastically selecting one of the plurality of instrument patterns in the instrument table selected corresponding to the comping pattern selected in the comping pattern selection process of step 804 in FIG. 8.

A detailed example of the frequency process of step S1102 is shown in the same flowchart in FIG. 10 as the detailed example of the frequency process of the comping pattern (step S903 in FIG. 9) described above. In FIG. 10, the CPU 101 first sets each frequency value of the instrument pattern indicated by the instrument frequency table selected in step S905 in FIG. 9 in the comping pattern selection process of step S804 in FIG. 8 as fi (1≤i≤N). In this case, the CPU 101 executes the calculation represented by the above-described Formula (2), calculates the calculation result as the random number maximum value rmax, and stores the calculation result in the RAM 103 (step S1001).

For example, in a case where the instrument frequency table exemplified in FIG. 7C corresponding to the instrument table exemplified in FIG. 7(a) is selected and the frequency values in the table are f1=50, f2=f3=10, and f4=20, according to Formula (2) described above: 50+10+10+20=90 is calculated as the random number maximum value rmax.

Next, the CPU 101 sequentially adds each frequency value fi (1≤i≤N) of the acquired N instrument frequency tables by the calculation shown in the above-described Formula (3) to create a new frequency value fnewj (1≤j≤N) having each addition result as a component (step S1002).

For example, using the frequency values f1=50, f2=10, f3=10, and f4=20 in the instrument frequency table exemplified in FIG. 7C, the new frequency value fnewj (1≤j≤4) is calculated as follows by the calculation of the above-described Formula (3).
50 . . . fnew1
50+10=60 . . . fnew2
50+10+10=70 . . . fnew3
50+10+10+20=90 . . . fnew4

Next, the CPU 101 generates a random number r between 0 and the random number maximum value rmax, for example, between 0 and 90 (step S1003).

Then, the CPU 101 determines any j (1≤j≤N) that satisfies the condition of the above-described Formula (4) between the generated random number r and the new frequency value fnewj (1≤j≤N), and selects the j-th instrument pattern corresponding to the j (step S1004).

For example, in the above-described example, in a case of “0<r≤fnew1=50”, the first instrument pattern INST1 in the instrument table in FIG. 7A is selected. In a case of “fnew1=50<r≤fnew2=60”, the second instrument pattern INST2 in the instrument table in FIG. 7A is selected. Further, in a case of “fnew2=60<r≤fnew3=70”, the third instrument pattern INST3 in the instrument table in FIG. 7A is selected. Then, in a case of “fnew3=70<r≤fnew4=90”, the fourth instrument pattern INST4 in the instrument table in FIG. 7A is selected.

Thereafter, the CPU 101 ends the frequency process of step S1102 in FIG. 11 exemplified in the flowchart in FIG. 10.

Returning to the description of FIG. 11, in a case where the number of columns is L which include each value in the “inst_count” row in the specified instrument table, the CPU 101 generates a set (gi, vi) (1≤i≤L) of the musical instrument tone gi and the velocity vi of each column described above of the instrument pattern row selected by the frequency process of step S1102 as the instrument pattern information (gi, vi) (1≤i≤L), and stores the set in the RAM 103 (step S1103).

For example, when the first instrument pattern INST1 in the instrument table of FIG. 7A is selected, the “inst_count” row in the instrument table of FIG. 7A includes values of “0” and “1”, and thus L=2. As a result, a set (g1, v1)=(SD, 30) of the musical instrument tone gi=“SD” and the velocity vi=30 in the column where the “inst_count” row is “0” and a set (g2, v2)=(BD, 40) of the musical instrument tone gi=“BD” and the velocity vi=40 in the column where the “inst_count” row is “1” are generated from the two rows of the instrument pattern INST1 as the instrument pattern information (gi, vi) (1≤i≤2) and stored in the RAM 103.

In FIG. 11, when the determination in step S1101 is NO, or after the process of step S1103, the CPU 101 reads the instrument pattern information (gi, vi) (1≤i≤L) stored in the RAM 103. Then, the CPU 101 selects the musical instrument tone and the velocity of the sound to be produced on the basis of the instrument pattern information of the set indicated by the instrument counter variable value stored in the RAM 103 among the instrument pattern information (gi, vi) (1≤i≤L) (as described above, step S1104).

For example, when the current instrument counter variable value is 0 (the determination in step S1101 is YES→S1102→S1103→S1104), the instrument pattern information (g1, v1)=(SD, 30) is selected. As a result, the musical instrument tone of the sound to be produced is determined to be “SD”, and the velocity is determined to be “30”.

For example, when the current instrument counter variable value is 1 (NO is determined in step S1101), the instrument pattern information (g2, v2)=(BD, 40) is selected. As a result, the musical instrument tone of the sound to be produced is determined to be “BD”, and the velocity is determined to be “40”.

Finally, the CPU 101 counts up the instrument counter variable value in the RAM 103 incrementally (step S1105). Thereafter, the CPU 101 ends the instrument pattern selection process of step S807 in FIG. 8 exemplified in the flowchart of FIG. 11.

Returning to the description of FIG. 8, the CPU 101 issues, to the sound source LSI 106 in FIG. 1, a sound production instruction of a musical sound by the musical instrument tone and the velocity selected by the instrument pattern selection process of step S807. As a result, the sound source LSI 106 generates musical sound waveform data of the musical instrument tone and the velocity that is instructed to be produced. Then, a musical sound of the comping sound is produced via the sound system 107 (as described above, step S808).

In FIG. 8, when the determination in step S806 is NO (not the sound production timing) or after the process of step S808, in a case where the tick counter variable value in the RAM 103 has been counted up in step S204, the CPU 101 counts down the remain_tick variable value in the RAM 103 decrementally. In a case where the tick counter variable value has not been counted up, the remain_tick variable value is not counted down (as described above, step S809).

Thereafter, the CPU 101 ends the variation drum process of step S203 in FIG. 2 exemplified in the flowchart in FIG. 8.

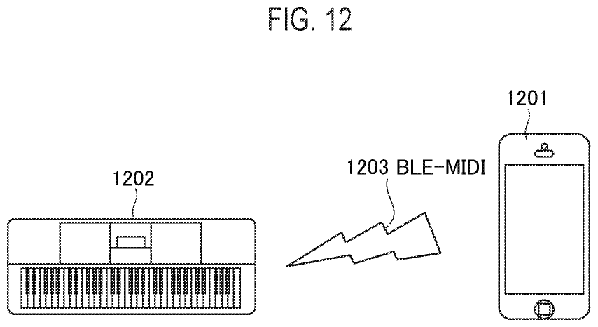

The embodiment described above is an embodiment in which the automatic performance device according to the present invention is built in the electronic keyboard instrument 100. On the other hand, the automatic performance device and the electronic musical instrument are individual devices, and may be configured as a performance system including the automatic performance device and the electronic musical instrument such as the electronic keyboard instrument. Specifically, for example, as illustrated in FIG. 12, the automatic performance device may be installed as an automatic performance application on, for example, a smartphone or a tablet terminal (hereinafter referred to as “smartphone or the like 1201”), and the electronic musical instrument may be, for example, an electronic keyboard instrument 1202 having no automatic performance function. In this case, the smartphone or the like 1201 and the electronic keyboard instrument 1202 perform wireless communication on the basis of a standard called MIDI over Bluetooth Low Energy (hereinafter referred to as “BLE-MIDI”). BLE-MIDI is a wireless communication standard between musical instruments that enables communication using the standard MIDI (Musical Instrument Digital Interface) for communication between musical instruments over the wireless standard Bluetooth Low Energy (registered trademark). The electronic keyboard instrument 1202 can be connected to the smartphone or the like 1201 according to the Bluetooth Low Energy standard. In this state, the automatic performance application executed on the smartphone or the like 1201 transmits the automatic performance data based on the automatic performance function described in FIGS. 2 to 11 to the electronic keyboard instrument 1202 as MIDI data via the communication path 1203 of the BLE-MIDI standard. The electronic keyboard instrument 1202 performs the automatic performance described with reference to FIGS. 2 to 11 based on the automatic performance MIDI data received according to the BLE-MIDI standard.

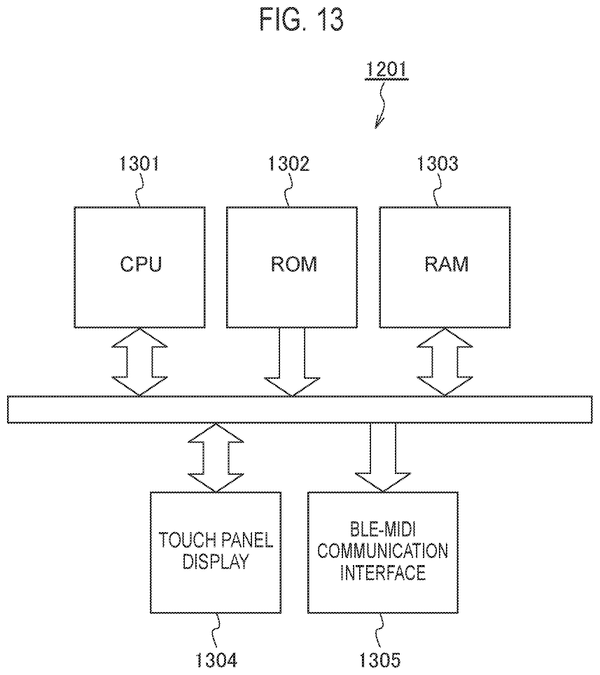

FIG. 13 is a diagram showing a hardware configuration example of the automatic performance device 1201 in another embodiment in which the automatic performance device and the electronic musical instrument having the connection form illustrated in FIG. 12 individually operate. In FIG. 13, the CPU 1301, the ROM 1302, and the RAM 1303 have the same functions as those of the CPU 101, the ROM 102, and the RAM 103 in FIG. 1. The CPU 1301 executes the program of the automatic performance application downloaded and installed in the RAM 1303, thereby realizing the same function as the automatic performance function described with reference to FIGS. 2 to 11 realized by the CPU 101 executing the control program. At this time, a function equivalent to that of the switch unit 105 in FIG. 1 is provided by the touch panel display 1304. Then, the automatic performance application converts the control data for automatic performance into automatic performance MIDI data and delivers the data to the BLE-MIDI communication interface 1305.

The BLE-MIDI communication interface 1305 transmits the automatic performance MIDI data generated by the automatic performance application to the electronic keyboard instrument 1202 according to the BLE-MIDI standard. As a result, the electronic keyboard instrument 1202 performs the same automatic performance as the case of the electronic keyboard instrument 100 in FIG. 1. The BLE-MIDI communication interface 1305 is an example of a communication means that can be used to transmit data for automatic performance generated by the automatic performance device 1201 to the electronic musical instrument such as the electronic keyboard instrument 1202 or the like. Instead of the BLE-MIDI communication interface 1305, an MIDI communication interface connected to the electronic keyboard instrument 1202 by a wired MIDI cable may be used.

In the conventional device, the pattern of the automatic performance is configured in units of bar. Therefore, in order to widen the range of variations of the phrase of the automatic performance, many pieces of pattern data are required.

In the conventional device, the type of musical instrument when the pattern data is automatically performed is designated in advance by the player or by the pattern data. For this reason, in order to widen the range of variations of a phrase of the automatic performance, it is necessary for the player to designate the type of the musical instrument for each automatic performance, or it is necessary to prepare many pieces of pattern data designating the type of the musical instrument.

As described above, conventionally, in order to realize automatic accompaniment of music having a rich variety of rhythm configurations, for example, it is necessary to create and store automatic performance patterns for a large number of bars and rhythm types such as jazz, rock, Waltz or the like, each of the automatic performance patterns having a different sound production configuration of a rhythm pattern and a rhythm tone type for each bar. Therefore, time and effort for creating such a large amount of automatic performance data and a storage medium for storing a large amount of automatic performance data are required, which leads to an increase in cost of the automatic performance device. Even in such a case, it is impossible to realize an improvised accompaniment in jazz through automatic performance.

One of the advantages in the disclosure is to provide an automatic performance device that is rich in change in both a phrase and a musical instrument tone of performance and enables an improvised accompaniment without preparing a large amount of automatic performance data.

As explained above, in the automatic performance device realized as each of the above-described embodiments, a drum phrase is not a predetermined phrase that is repeated, but a variable-length phrase whose occurrence probability is specified per beat to generate a phrase suitable for the replaying timing. In addition, the drum phrase is not always automatically played by the musical instrument in a uniquely determined drum set, but rather one combination is stochastically selected and produced from several combinations of musical instruments that have musical meaning in the phrase. With these features, the accompaniment performance in which the previously programmed performance data is repeatedly played with an arbitrary length is randomized in a certain fixed rule, so that it is no longer a monotonous repeated performance, and it is possible to reproduce a performance close to a live performance played by a human.

In addition, by adopting and combining variable-length phrases per beat in the “certain fixed rule” described above, it is possible to reproduce more varied performances with a smaller storage capacity than the conventional technique.

What is claimed is:

1. An automatic performance device executing a process comprising:
determining stochastically one of a plurality of timing patterns indicating a sound production timing of a musical instrument sound, and
determining a musical instrument tone designation table associated with the determined timing pattern from a plurality of musical instrument tone designation tables.

2. The automatic performance device according to claim 1, wherein
the timing pattern is determined based on timing pattern frequency data indicating easiness of selection of each of the plurality of timing patterns.

3. The automatic performance device according to claim 1, wherein the process further comprising,
determining a musical instrument tone produced at the sound production timing based on musical instrument tone frequency data indicating easiness of selection of each of a plurality of different musical instrument tones included in the musical instrument tone designation table.

4. The automatic performance device according to claim 3, wherein the process further comprising,
performing automatic performance based on the determined timing pattern and the determined musical instrument tone together with performing of a basic accompaniment pattern.

5. The automatic performance device according to claim 1, wherein
the musical instrument tone designation table further includes data designating a musical instrument tone to be produced at the sound production timing and data designating a velocity when the musical instrument tone is produced.

6. The automatic performance device according to claim wherein the process further comprising,
performing automatic performance based on the determined timing pattern, the determined musical instrument tone and velocity together with performing of a basic accompaniment pattern.

7. The automatic performance device according to claim 1, further comprising,
a communication circuit transmitting data for automatic performance generated to an electronic musical instrument.

8. An electronic musical instrument comprising:
the automatic performance device according to claim 1; and
a playing operator.

9. A performance system comprising:
the automatic performance device according to claim 7; and
an electronic musical instrument.

10. An automatic performance method executing a process, the process comprising:
determining stochastically one of a plurality of timing patterns indicating a sound production timing of a musical instrument sound, and
determining a musical instrument tone designation table associated with the determined timing pattern from a plurality of musical instrument tone designation tables.

11. A program for causing a computer to execute a process comprising:
determining stochastically one of a plurality of timing patterns indicating a sound production timing of a musical instrument sound, and determining a musical instrument tone designation table associated with the determined timing pattern from a plurality of musical instrument tone designation tables.
